(19) United States
(12) Patent Application Publication
(10) Pub. No.: US 2026/0298623 A1
(43) Pub. Date: Oct. 1, 2026

(54) IMAGING SYSTEM FOR IMAGING A SCENE COMPRISING ONE OR MORE OBJECTS WITH TRANSPARENT SURFACES

(71) Applicant: Zivid AS, Oslo (NO)

(72) Inventors: Henrik SCHUMANN-OLSEN, Oslo (NO); Martin INGVALDSEN, Oslo (NO); Jens T. THIELEMANN, Oslo (NO)

(21) Appl. No.: 19/489,129

(22) PCT Filed: May 29, 2024
(86) PCT No.: PCT/EP2024/064850

§ 371 Date: Dec. 1, 2025

(30) Foreign Application Priority Data
May 30, 2023 (GB) 2308083.1

(51) Int. Cl. G01B 11/25

(52) U.S. Cl. CPC G01B 11/2518

(57) ABSTRACT

An imaging system for imaging a scene including one or more objects, the system including: a light source arranged to illuminate the scene by projecting light rays through an array of points in space, wherein for each one of a sequence of time steps, the light source is configured to illuminate the scene with a different illumination pattern by projecting light rays through a different group of points in the array; a detector including an array of pixel elements, the detector being arranged to capture an image at each time step by detecting, on the array of pixel elements, light projected towards the scene and reflected from one or more surfaces of the object towards the detector; and an image processor configured to: process the captured images to determine, for each pixel element, a light signal incident on the pixel element during the course of the sequence of time steps; and determine, based on the light signal incident on the pixel element at each time step and knowledge of the illumination pattern projected at each time step, that the object includes a first surface that is at least partially transparent, at least a portion of the light incident on the first surface being reflected towards the detector, and another portion being reflected from a second surface located at a greater depth in the scene.

### FIELD

Embodiments described herein relate to an imaging system for imaging a scene comprising one or more objects.

### BACKGROUND

Three-dimensional surface imaging (3D surface imaging) is a fast growing field of technology. The term “3D surface imaging” as used herein can be understood to refer to the process of generating a 3D representation of the surface(s) of an object by capturing spatial information in all three dimensions—in other words, by capturing depth information in addition to the two-dimensional spatial information present in a conventional image or photograph. This 3D representation can be visually displayed as a “3D image” on a screen, for example.

A number of different techniques can be used to obtain the data required to generate a 3D image of an object's surface. These techniques include, but are not limited to, structured light illumination, time of flight imaging, holographic techniques, stereo systems (both active and passive) and laser line triangulation. In each case, the data may be captured in the form of a “point cloud”, in which intensity values are recorded for different points in three-dimensional space, with each point in the cloud having its own set of {x, y, z} coordinates and an associated intensity value I.

One challenge that arises in this field is of obtaining 3D images of objects with transparent surfaces. In part, this is because the transparent surfaces will only reflect a small portion of the light projected onto them, leading to a low signal to noise ratio that carries through in efforts to reconstruct the objects from the captured images. The problem is further complicated by the need to accurately distinguish between signals reflected from an upper surface of the object(s) and ones which lie deeper within the object but which can still reflect light back through that upper surface. These signals may differ in magnitude depending on the nature of the surfaces, with the signal from any one surface depending on its particular level of reflectance, transmittance and absorption. As an example, if imaging a translucent soap bottle on a black, highly absorptive background, the camera will see a different mix of signals than if imaging a transparent wine glass placed on a white, highly reflective surface.

The ability to successfully identify transparent surfaces when building 3D images of objects would be advantageous for numerous applications. One particular application lies in the field of automated warehouses, where robotic agents are used to identify and collect goods from shelves and other storage facilities. These agents may use cameras to map the contours of the objects they seek to pick up and transport through the warehouse. Such cameras may fail to properly identify the (transparent) plastic packaging that such goods are often contained in, however, meaning that the agent will either fail to retrieve the item or else damage it during collection.

It is desirable, therefore, to provide enhanced means for identifying the presence of transparent surfaces when building 3D images of objects.

### SUMMARY

According to a first aspect of the present invention, there is provided an imaging system for imaging a scene comprising one or more objects, the system comprising:
a light source arranged to illuminate the scene by projecting light rays through an array of points in space, wherein for each one of a sequence of time steps, the light source is configured to illuminate the scene with a different illumination pattern by projecting light rays through a different group of points in the array;
a detector comprising an array of pixel elements, the detector being arranged to capture an image at each time step by detecting, on the array of pixel elements, light projected towards the scene and reflected from one or more surfaces of the object towards the detector; and
an image processor configured to:
   process the captured images to determine, for each pixel element, a light signal incident on the pixel element during the course of the sequence of time steps; and
   determine, based on the light signal incident on the pixel element at each time step and knowledge of the illumination pattern projected at each time step, that the object includes a first surface that is at least partially transparent, at least a portion of the light incident on the first surface being reflected towards the detector, and another portion being reflected from a second surface located at a greater depth in the scene.

The image processor may be configured to determine, based on the light signal incident on the pixel element at each time step and the illumination pattern at each time step, that the light signal includes a first portion of light reflected from the first surface, and a second portion of light reflected from the second surface.

The first portion of light and the second portion of light may travel along the same path between the object and the detector.

The image processor may be further configured to determine, based on the light signal incident on the pixel element at each time step and the illumination pattern at each time step:
a first location in the array of illumination points through which the light reflected by the first surface and incident on the pixel element was projected.

The image processor may be further configured to determine, based on the light signal incident on the pixel element at each time step and the illumination pattern projected at each time step:
a second location in the array of illumination points through which the light that passed through the first surface and was reflected from the second surface towards the pixel element was projected.

The image processor may be configured to determine, based on the first location or second location, a distance between the detector and the first surface and/or second surface.

The illumination patterns may comprise a series of line patterns in which one or more lines are projected onto the scene. Each line pattern may comprise a plurality of parallel lines. Each line may be formed by rays of light that pass through a respective row or column of the array of illumination points. The line patterns may chosen such that each line is projected onto the scene once over the sequence of time steps.

The image processor may be configured to determine that the object includes a first surface that is at least partially transparent by identifying the presence of two or more peaks in the light signal incident on the pixel element over the course of projecting the lines patterns onto the scene.

The image processor may be configured to identify a region of the array of illumination points through which light reflected by the first surface and incident on the pixel element passed based on the peaks in the light signal incident on the pixel element during the course of illuminating the scene with the plurality of line patterns.

The illumination patterns may further comprise a series of coded patterns from which can be determined a global location in the array of illumination points through which light rays incident on each pixel of the detector pass.

The coded patterns may comprise gray code patterns.

The image processor may be configured to identify a region of the array of illumination points through which light reflected by the first surface and incident on the pixel element passed based on (i) the peaks in the light signal incident on the pixel element during the course of illuminating the scene with the plurality of lines patterns and/or (ii) the signal seen in the detector pixel over the course of illuminating the scene with the coded patterns.

The system may be configured to generate the illumination patterns by defining an illumination sequence for respective regions of points in the array of illumination points, the illumination sequence specifying a variation in the amplitude of light projected through the respective region over the course of the sequence of time steps. The illumination sequence may be different for each region. Each region of points may comprise a respective line of points in the array of illumination points.

For each pixel element, the image processor may be configured to model the light signal incident on the pixel element over the sequence of time steps as a function of contributions from the regions in the array of illumination points. The image processor may be configured to determine a number of regions N whose illumination sequences, when combined, result in the light signal seen on the detector. The image processor may be configured to determine that the object includes a first surface that is at least partially transparent and a second surface in the event that N≥2.

Each illumination sequence may be encoded using one or more bits, the one or more bits defining a relative amplitude of light to be projected through the region of points towards the scene in each time step.

The one or more bits may specify a frequency modulation to be applied to the light projected through the region of points over the course of the sequence of time steps.

Each illumination sequence may be encoded as a sequence of bits, wherein each bit is associated with a respective time step, the value of each bit defining a relative amplitude of light to be projected through the region of points towards the scene in the respective time step.

For each region, the illumination sequence may define one or more time steps at which light is to be projected from the region with a first amplitude, and one or more time steps at which the amplitude of light projected from the region is either reduced compared to the first amplitude or is zero.

The illumination sequences may be defined such that for each one of the region of points, the number of time steps in the sequence for which light will be projected with the first amplitude is the same.

Each region of points may comprise a respective line of points in the array of illumination points. The number of bit changes between the illumination sequences for each consecutive pair of lines may be the same.

The regions may comprise columns or rows of points in the array of illumination points. The sequence of bits for each region may be defined such that for any one region, a correlation between the sequence of bits for that region and the sequence of bit for other regions within a disparity window of that region is reduced compared to the correlation between the sequence of bits for that region and the sequence of bits for other regions outside of the disparity window. The disparity window may define the maximum number of consecutive regions in the array of illumination points, the light from which is capable of being detected on a single pixel of the detector according to the geometry of the system.

The light source may comprise a projector having an array of projector elements, each illumination pattern being generated by activating one or more of the projector elements.

According to a second aspect of the present invention, there is provided a robotic device configured to manipulate a physical object, wherein the robotic device is configured to identify the object as having a transparent surface by using a system according to the first aspect of the present invention.

According to a third aspect of the present invention, there is provided a warehouse comprising one or robotic devices according to the second aspect of the present invention.

According to a fourth aspect of the present invention, there is provided a computer-readable medium comprising computer executable instructions that when executed by a computer will cause the computer to operate a system according to the first aspect of the present invention.

According to a fifth aspect of the present invention, there is provided a computer-readable medium comprising computer executable instructions that when executed by a computer operate a robotic device according to the second aspect of the present invention.

### BRIEF DESCRIPTION OF DRAWINGS

Embodiments of the invention will now be described by way of example with reference to the accompanying drawings in which:

FIG. 1 shows an example of an imaging system according to an embodiment;

FIGS. 2A and 2B show examples of light sources for use in a system according to an embodiment;

FIG. 3A shows an example of how rays being emitted by a light source at a first point in time are reflected from an object towards a detector in an imaging system according to an embodiment;

FIG. 3B shows an example of how rays being emitted by the light source of FIG. 3A at a second point in time are reflected from the object towards the detector;

FIGS. 4A to 4B show an example of such how a temporal sequence of illumination patterns may be constructed in one embodiment;

FIG. 5A shows an example scene including two objects to be imaged;

FIG. 5B shows the scene of FIG. 5A with a particular row of camera pixels highlighted;

FIG. 6 shows images captured on a camera when different line patterns are projected onto and reflected from objects in the field of view; according to an embodiment;

FIG. 7 shows a table of intensity values measured at a camera pixel in each one of a sequence of time steps, according to an embodiment;

FIG. 8 shows the intensity values of FIG. 7 plotted on a graph;

FIG. 9 shows an example of gray code patterns used in acquiring the data shown in FIG. 8;

FIG. 10 shows a plot indicating the columns in an array of illumination points from which light incident on different camera pixels is determined to emanate, based on the images captured when projecting a series of line patterns and gray code patterns onto the scene;

FIG. 11 shows the results of combining the data from the line patterns and the gray code patterns in FIG. 10;

FIG. 12 shows a reproduction of the scene shown in FIG. 5A;

FIG. 13 shows a 3D reconstruction of the objects in the scene of FIG. 5A, as obtained using an imaging system according to an embodiment;

FIG. 14 shows an example of how a plurality of illumination sequences may be defined by using a code matrix, according to an embodiment;

FIG. 15 shows example images captured on the camera when using these different illumination patterns to illuminate the same field of view as shown in FIG. 6;

FIGS. 16a and 16B show examples of how illumination sequences associated with different regions in an array of illumination points may contribute to a signal detected at a camera pixel, according to an embodiment;

FIG. 17 shows a series of images captured on the camera when using different illumination patterns to illuminate the same field of view;

FIG. 18 shows intensity values for a single pixel in the image sequence of FIG. 17;

FIG. 19 shows a plot indicating the columns in an array of illumination points from which light incident on different camera pixels is determined to emanate when illuminating the scene with the illumination sequences shown in FIG. 14;

FIG. 20 shows a further plot indicating the columns in an array of illumination points from which light incident on different camera pixels is determined to emanate when illuminating the scene with the illumination sequences shown in FIG. 14;

FIG. 21 shows a cross-correlation matrix for the codes in the matrix of FIG. 14;

FIG. 22 shows a magnified section of the cross-correlation matrix of FIG. 21;

FIG. 23 shows another example of how a plurality of illumination sequences may be defined by using a code matrix, according to an embodiment;

FIG. 24 shows a cross-correlation matrix for the codes in the matrix of FIG. 23;

FIG. 25 shows a plot indicating the columns in an array of illumination points from which light incident on different camera pixels is determined to emanate, when illuminating the scene with the illumination sequences shown in FIG. 23; and

FIG. 26 shows an example in which an imaging system according to an embodiment is employed by a robotic device in a factory or warehouse.

### DETAILED DESCRIPTION

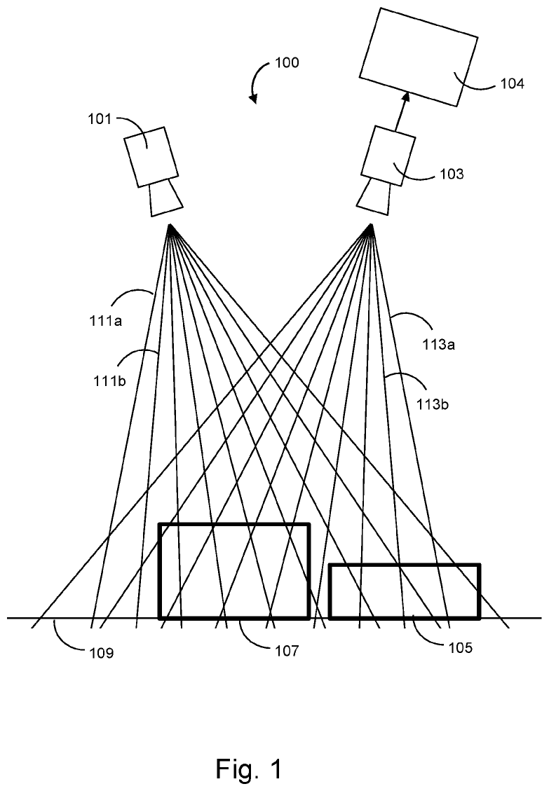

FIG. 1 shows an example of an imaging system 100 according to an embodiment. The system comprises a light source 101 and one or more detectors 103, which are used to capture images of a scene comprising one or more objects 105, 107 placed on a surface 109. The detector is mounted at an offset to the light source. An image processor 104 is used to process the images captured on the detector.

The light source 101 may be one of a number of different types of light source, capable of projecting light rays through an array of illumination points in space, and able to generate different illumination patterns by projecting light through different groups of points within the array at different times. For example, the light source 101 may comprise a spatial light modulator, an array of LEDs or a moving laser line or spot.

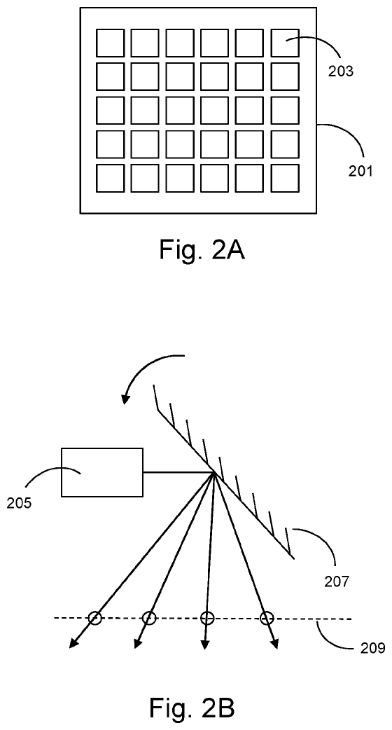

FIGS. 2A and 2B show two examples of such a light source. In FIG. 2A, the light source 201 is a projector, comprising a plurality of individually addressable pixel elements 203. The layout of the pixel elements in the projector defines an array of illumination points. Different groups of the pixel elements 203 may be activated at different times, to generate the illumination patterns. FIG. 2B shows an alternative type of light source, comprising a point source such as a laser 205, that is arranged to project light onto a mirror 207. The mirror 207 can be rotated quickly, causing the laser beam to sweep through a plane 209 as it is directed towards the scene. Here, an array of illumination points is formed of points within the plane 209 that the different rays of light from the laser pass through as the mirror rotates, each ray having a specific direction. The laser may be time synchronized with the mirror and modulated to generate the desired patterns. It will be appreciated that such an array of illumination points may be formed in other ways, depending on the light source used.

In the present embodiment, the light source 101 comprises a projector having an array of individually addressable pixel elements, which can be activated to form different patterns of illumination. Individual regions of the projector elements, such as columns or rows may be activated so as to project one or more shapes (e.g. lines) of light 111a, 111b, . . . 111n onto the object(s) in the field of view.

The detector 105 comprises an array of pixel elements capable of detecting light projected from the light source 101 and reflected from the objects in the scene. In the present embodiment, the detector comprises a camera such as a CCD sensor, a CMOS sensor, or event based vision sensor (EVS), for example. Different pixels in the detector will detect light rays 113a, 113b, . . . 113n a reflected from different points on the objects in the field of view, allowing the detector to build up a 2D image of the scene.

In general, for each point on an object in the field of view, two corresponding positions can be defined: (i) the position in the array of illumination points from which the light that is incident on that point on the object is emanating, and (ii) the camera pixel coordinate i.e. the pixel position in the camera at which the light reflected by that point on the object is captured. Using a suitable algorithm, and taking into account the relative positions of the camera and projector (these relative positions being determined straightforwardly using a standard calibration measurement), the images captured at the camera can be processed in order to determine, for each camera pixel, the corresponding coordinate in the array of illumination points. Having established, for a given camera pixel p, that the pixel p is receiving light from a point on the projector g, for example, a position estimate E of a point on the object having coordinates {x, y, z} can be derived by using known triangulation methods, akin to those used for stereo vision, taking into consideration the lens parameters, distance between the camera and projector etc. Such methods are described, for example, in “3D Imaging, Analysis and Applications, Chapter 3.4” (Liu, Y. et al., Springer Cham, 11/12 Sep. 2020, ISBN 978-3-030-44070-1). Similar methods can be used where the light source is a point source such as in FIG. 2B.

The above picture is complicated where the object(s) include one or more transparent surfaces. Here, the signal detected at each camera pixel may be a sum of signals reflected from different depths within the object. For example, when looking down on the object as shown in FIG. 1, a camera pixel may detect a small portion of light reflected from a transparent top surface of the object, whilst also receiving light that has passed through that transparent top surface and been reflected up from the bottom surface of the object or the material the object has been placed upon. In order to recognize the presence of the transparent surface in the object (and in turn, accurately determine the depth of each surface) it is necessary to “unmix” the signals received at the same camera pixel from these different surfaces, by determining where these different rays of light emanate from in the array of illumination points.

Embodiments described herein allow the system to recognize that the object comprises one or more transparent surfaces, by using a temporal sequence of light patterns to illuminate the object(s) and processing the captured images in the knowledge of the illumination patterns. Each pattern of light can be programmed using the projector. By monitoring the intensity received in each camera pixel as the pattern of light projected onto the object(s) changes in time, it is possible to identify where the signal incident on a particular camera pixel is actually composed of two or more distinct signals that travel along the same path between the object and that camera pixel, but which emanate from different points in the array of illumination points, and which are being reflected from a first transparent surface of the object and a second surface located at a greater depth in the scene, respectively.

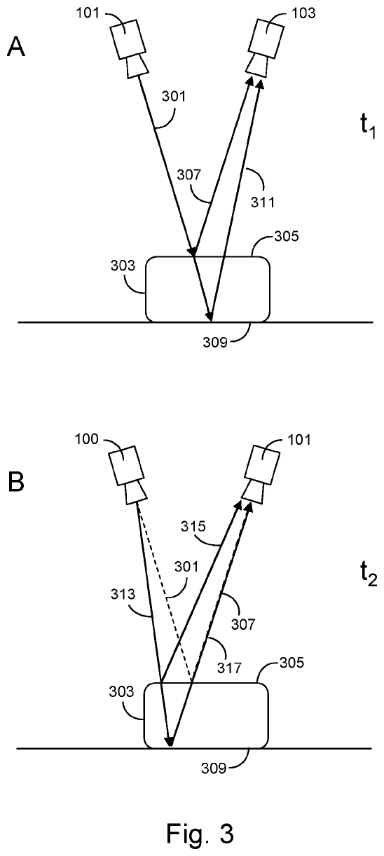

The above principle can be further understood with reference to FIGS. 3A and 3B. In this example, the light source is assumed to be a projector, with different columns of the projector 101 being activated over time and images of the object 303 being captured on the camera 103 at each individual time step.

FIG. 3A shows the system at a first time point t₁. Here, a ray of light 301 from a first column of the projector elements is emitted towards the object 303. On reaching the top surface 305 of the object, a small portion of the projected light is reflected back to towards the camera, as indicated by ray 307. Meanwhile, the majority of light from the first column of projector elements passes through the object 303 and is reflected from the second surface 309. From here, the light passes back up through the object 303 and towards the camera 103, as indicated by ray 311. As a result of the geometry of the system, the rays 307 and 311 reflected from the top and bottom surfaces of the object 303 will be incident at different pixels on the camera 103.

Turning to FIG. 3B, this shows the arrangement as in FIG. 3A at a later time point t₂. Here, a second column of the projector elements is activated, rather than the first column of projector elements as in the time step t₁ shown in FIG. 3A. The second column of projector elements emit a ray of light 313 towards the object. For purpose of explanation, the ray 301 as emitted by the first column of projector elements at the earlier time step in FIG. 3A is shown in FIG. 3B as a dashed line; it will be appreciated that this is for comparison only, and the ray 301 will not, in fact, be present at this later time step since the first column of projector elements is no longer active. As before, a small portion of light will be reflected when the ray 313 reaches the top surface 305 of the object, as shown by ray 315. Meanwhile, the majority of light from the second column of projector elements passes through the object 303 and is reflected from the second surface 309. From here, the light passes back up through the object and towards the camera, as indicated by ray 317.

Importantly, the point on the camera at which the ray 317 in FIG. 3B is incident coincides with that of the ray 307 in the earlier time step; that is, the ray 317, on leaving the object, travels along the same path as the ray 307 that was projected by the first column of projector elements at t₁ and is detected in the same camera pixel as the ray 307. Since it is known which projector elements were active in each time step, it is possible to determine the projector elements from which the two rays 307 and 317 originate, even though both are detected in the same pixel of the camera (and from the camera's point of view, appear to emanate from the same point in the scene being imaged). The information so obtained can then be used to determine the depth of the two surfaces as measured from the camera and in turn build up a 3D image of the object 303.

Accordingly, by illuminating the field of view with different patterns of light at different points in time, and measuring the intensity of the light that is incident on each camera pixel at those different points in time, it is possible to determine the point in the array of illumination points that each ray of light that is incident on the same camera pixel passes through.

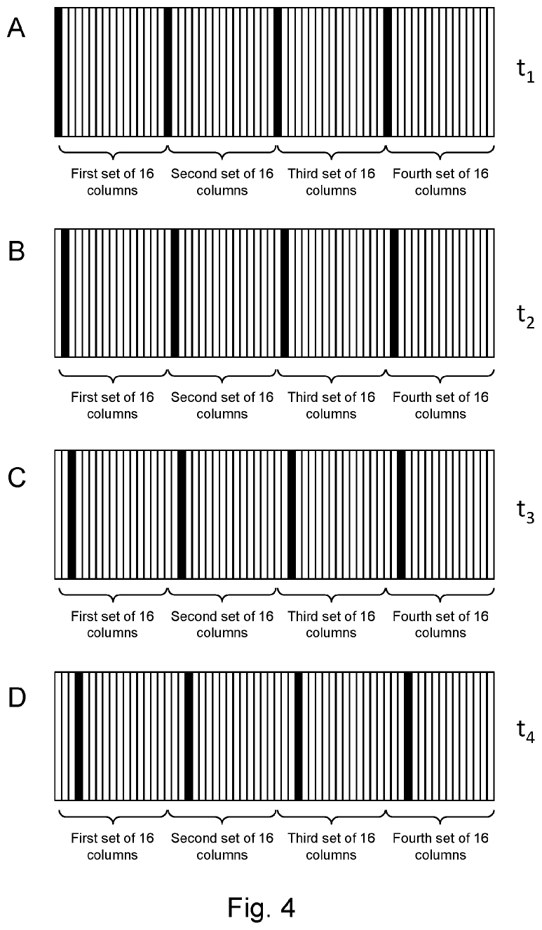

FIG. 4 shows an example of such how the temporal sequence of illumination patterns may be constructed in one embodiment. Here, the illumination patters include a series of line patterns, which are generated by activating different columns of the projector light elements. The columns of the projector elements can be thought of as being divided into a series of m groups, each group containing a number K of columns. For example, the group m=1 may include columns 1 to K, the column m=2 may include columns K+1 to 2K, the group m=3 may include columns 2K+1 to 3K and so on. If the projector has a total number of columns N, and the number of columns per group is K, then the number of groups m will be N/K.

In the example shown in FIG. 4, the value K is chosen as 16. For the purpose of explanation, FIG. 4 only shows the first four groups of columns; it will be appreciated, however, that the projector may comprise a much larger number of columns across its width. For example, the total number of columns N may be of the order of 1968. Assuming that the number of columns K in each group is 16, this will equate to a total number of groups m=123.

At each time step, a single column of projector elements will be activated in each group of columns. FIG. 4A shows the columns illuminated at the first time step t₁ in the sequence. Here, the first column in each group of columns is illuminated. FIG. 4B shows the columns illuminated at the second time step in the sequence t₂. Here, the second column in each group of columns is illuminated. FIG. 4C shows the columns illuminated at the third time step in the sequence t₃. Here, the third column in each group of columns is illuminated. FIG. 4D shows the columns illuminated at the fourth time step in the sequence t₄. Here, the fourth column in each group of columns is illuminated.

Since there are 16 columns in each group, the illuminated lines remain spaced apart by 16 columns at each time step. It also follows that the total number of patterns in the sequence will be equal to the pitch (column spacing) K; once the 16th column in each group has been activated, each one of the columns of projector elements will have been activated once across the sequence of time steps. (It will be appreciated that in some embodiments, the lines of illumination may be widened so that two or more adjacent columns of projector pixels are illuminated at once; in each case, the column(s) of elements to be activated in the subsequent time step will begin with the first column that was not illuminated in the previous time step. So, for example, columns 1 and 2 may be activated at time t₁, columns 3 and 4 may be activated at time t₂ and columns 5 and 6 may be activated at time t₃, etc. Doing so can help to reduce the overall acquisition time, at the expense of requiring a higher minimum height of the object in order to resolve the upper and lower surfaces of that object).

In some embodiments, the line pitch K may be pre-defined using knowledge of the working range and/or maximum transparent object thickness in the scene. For example, the line pitch may be chosen such that the first and second surface of the object are separated by a distance less than the width of K/2 projector columns.

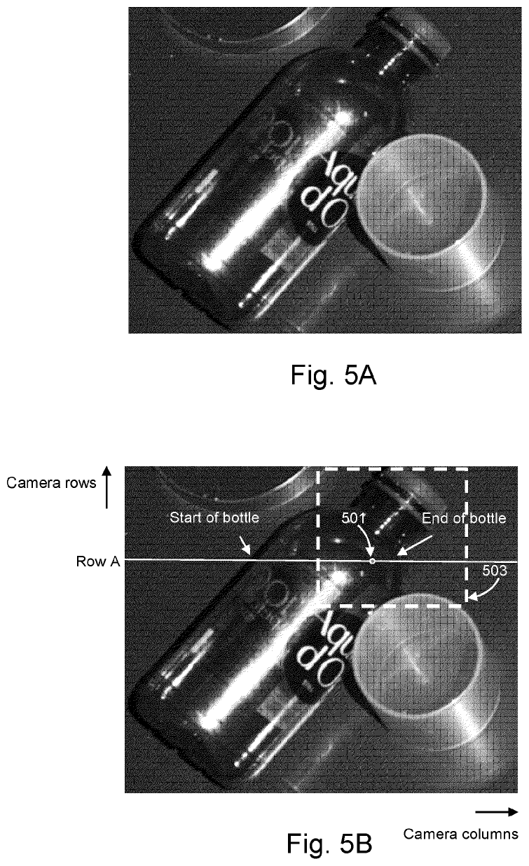

FIG. 5A shows an example scene including two objects to be imaged: a bottle and a lid, both of which are at least partially transparent. FIG. 5B shows the same field of view, with a particular row of camera pixels (Row A) highlighted. Here, the bottle has a first edge that is detected in pixel element 206 of Row A on the camera, and a second edge that is detected in pixel element 448 of that row. Also shown in FIG. 5B is the location of a camera pixel element 501 that lies in Row A, between the two edges of the bottle.

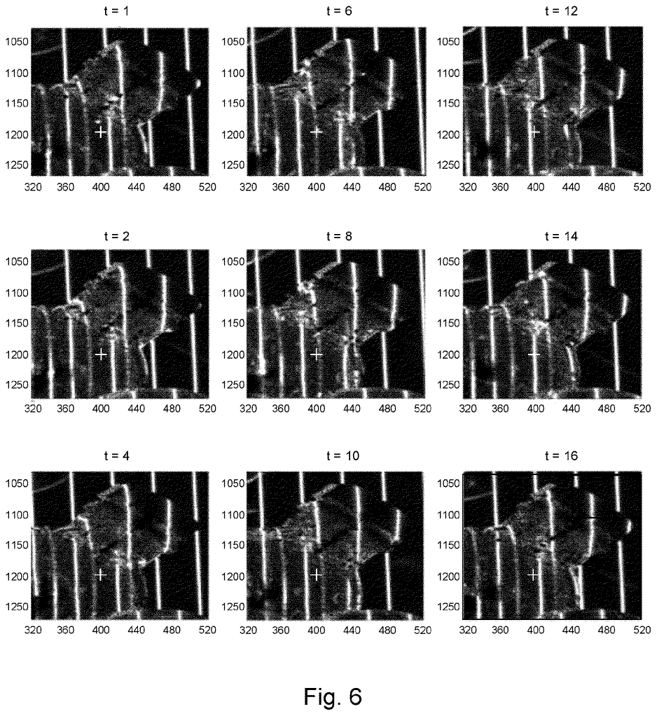

Turning to FIG. 6, this shows images captured on the camera when the different line patterns are projected onto—and reflected from—the objects in the field of view. (For purpose of explanation, the images shown in FIG. 6 are taken from a smaller region of the field of view, as indicated by the dashed rectangle 503 in FIG. 5). Each image can be seen to comprise a series of bright lines that correspond to regions in the scene where light projected from the projector is incident on the objects and being reflected towards the detector. The remaining parts of the scene, which do not receive any light from the projector, remain in darkness. As a result of the different height profiles of the bottle and lid, the pattern of lines as seen at the camera is distorted; the lines no longer appear as uniformly straight, but appear to bend and/or feature discontinuities that coincide with the edges of the objects.

As shown in FIG. 6, the image detected at the camera changes over time as the projector cycles through the different illumination patterns (here, the sequence of line patterns comprises a total of 16 steps, but for brevity only the image from the first time step t₁ and each even numbered time step is shown in the figure). The activation of the different columns of projector elements at each time step makes it appear that the vertical lines are moving across the field of view.

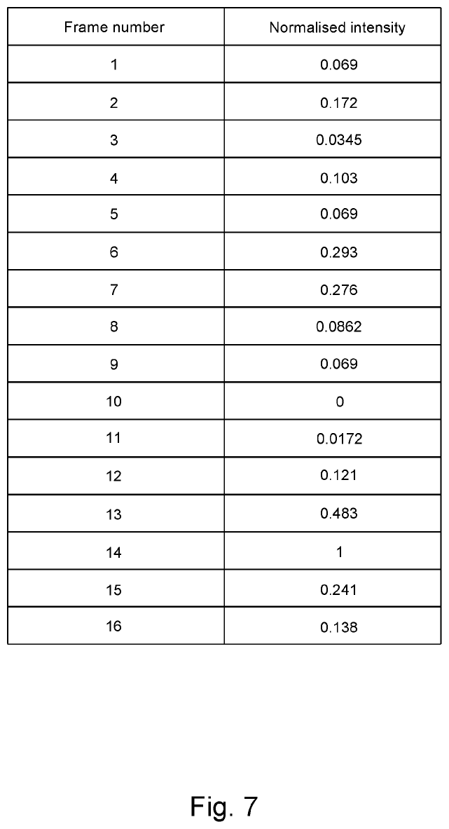

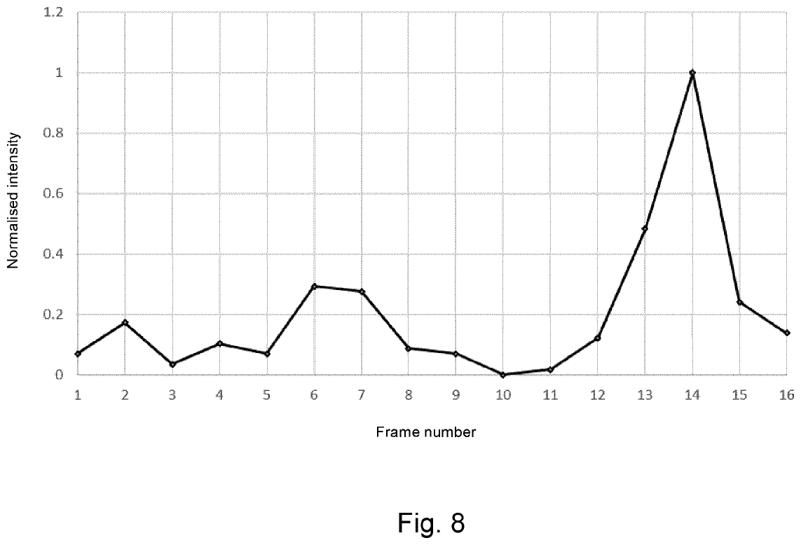

Returning to the camera pixel 501 as shown in FIG. 5B, it is possible to measure the intensity of light received in that camera pixel over the course of the sequence of images. FIG. 7 shows the intensity measured at the camera pixel at each one of the 16 time steps in the sequence of line patterns, as normalized by the time step having the highest intensity value across the sequence of images. FIG. 8 shows the normalized measurements of intensity plotted on a graph. Here, it is possible to discern clearly two peaks in intensity at time points t₆ and t₁₄; these peaks indicate frames in the temporal sequence of images in which a signal reflected from one of the object surfaces was reflected back to the camera pixel p. A threshold may be applied to separate genuine peaks in the signal from background noise.

The presence of the two peaks in the signal shown in FIG. 7 serves to indicate that the object includes at least one transparent surface. Since each column of the projector is illuminated once only in the sequence of line patterns, and the camera pixel sees two peaks over the course of that signal, it follows that the camera pixel is detecting light projected from two separate columns in the projector array. From the camera's point of view, both those signals are travelling along the same path from the object to the camera. The geometry of the system means that it can be inferred that light in one of those signals is being reflected from a surface below that from which the other signal is being reflected. It follows that the upper surface will then be at least partially transparent.

By identifying the position in the temporal sequence of the two peaks, and knowing which of the projector columns were active when those images were captured, it is possible to determine which of the projector columns the rays incident on the camera pixel p originate from. Note that at this stage, it is not possible to determine the global position of those columns as the camera does not know which group of columns m the rays originate from; that is, referring to FIG. 4, it is not known whether the columns are those of the first set of 16 columns, or the second set of 16 columns, or the third set of columns etc. Instead, what can be determined at this stage is which column number 1 to 16 (within the as yet unspecified set of columns) was illuminating the scene when a reflection was detected at the camera pixel p—in this case, column numbers 6 and 14.

In order to obtain the absolute column number, an additional set of coded patterns may be projected onto the field of view so as to enable the global localization of the column position. The coded patterns may comprise, for example, gray codes i.e. a set of binary codes, with the property that only a single bit changes between subsequent codes (this makes the codes more robust against e.g. lens blurring). The gray codes may be projected, for example, such that projector columns 0 and 1 project a gray code index 0, projector columns 2 and 3 project a gray code index 1, and in more general projector columns y, y+1 project a gray code index y/Z, where Z is the number of repetitions of each code (in the example above Z=2). For a projector that is 1020 pixels wide, and with the same code index used for every two subsequent projector columns, one would need to generate 510 different gray codes. Minimally, this will require a gray code consisting of T=9 bits, yielding 2⁹=512 different codes. The first image will project the first bit of all the codes, the second image will project the second bit of all the codes, and so on. The number of columns Z over which each code repeats is a variable that can be tuned (more repetitions means fewer gray code patterns), although in general it is preferable for the number of gray codes to be rather high, such that the number of columns having the same gray code is smaller than the pitch K of the lines used in each pattern, and with sufficient extra margin to cover thick transparent objects.

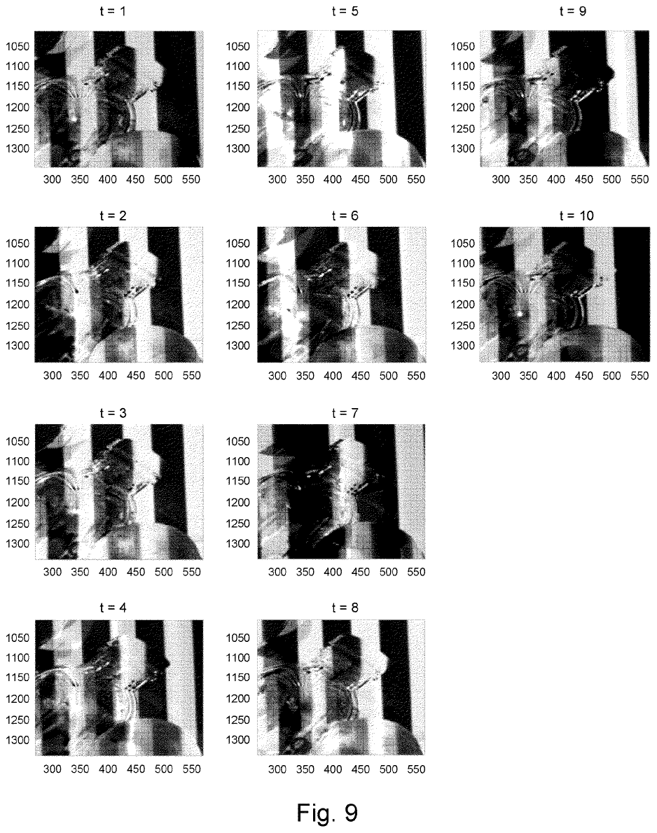

FIG. 9 shows an example of 10 gray codes that may be used in conjunction with the 16 line patterns used to capture the data shown in the graph of FIG. 8. If we let gc(r,c,t) be the value of the camera pixel at position (r, c) at time t (which is equivalent to image number t) within the set of images comprising the gray code images, the gray codes can be used to identify the projector column through the following steps:
1. For each camera pixel, find the minimum and maximum pixel intensity across the images, respectively a(r, c) and b(r, c).
2. Calculate a per camera-pixel threshold

$$t ( r , c ) = \frac{a ( r , c ) + b ( r , c )}{2}$$

3. Classify each camera pixel observation as:

$$x ( r , c , t ) = \{ \begin{matrix}1 , & gc ( r , c , t ) > t ( r , c ) \\ 0 , & otherwise\end{matrix} \qquad ( Equation 1 )$$

4. Convert the pixel observation into its Gray Code number by calculating

$$n ( r , c ) = {\sum }_{t = 0}^{T} x ( r , c , t ) \cdot {2}^{t} \qquad ( Equation 2 )$$

5. Use a lookup table that returns code index i when the gray code number n is input.
6. Convert the code to projector column by multiplying it with Z.

The above algorithm assumes that the gray codes are designed such the code consisting of only zero-bits and only one-bits are excluded from the projected signal. It will be appreciated that other methods are available to decode the gray codes and retrieve the underlying column numbers, as described in “3D Imaging, Analysis and Applications” (Liu, Y. et al., Springer Cham, 11/12 Sep. 2020, ISBN 978-3-030-44070-1), which contains a recent overview of state-of-the-art methods.

In the case of transparent objects, a mixture of two gray codes will be returned to the camera. In practice, it has been observed that the above algorithm can recover the strongest of the two gray codes being mixed and returned to the camera. This will correspond to the return signal from one of the surfaces (the strongest) being observed by the camera.

Having processed both the images captured when illuminating the scene with the line patterns shown in FIG. 6 and the images captured when illuminating the scene with the gray codes shown in FIG. 9, two sets of results will be obtained for the projector columns. We can use gp(r, c) to denote the projector column returned for a camera pixel from the gray code as per the above algorithm, and mp(r, c, kᵢ) to denote the projector column(s) returned when illuminating the scene with the line patterns. Here, kᵢ indicates the position (i.e. frame number) of the i^{th} peak seen at the camera pixel when illuminating the scene with the line patterns (in the example seen in FIGS. 8, k₁=6 and k₂=14). As before, we denote the pitch of the lines in the line patterns as K.

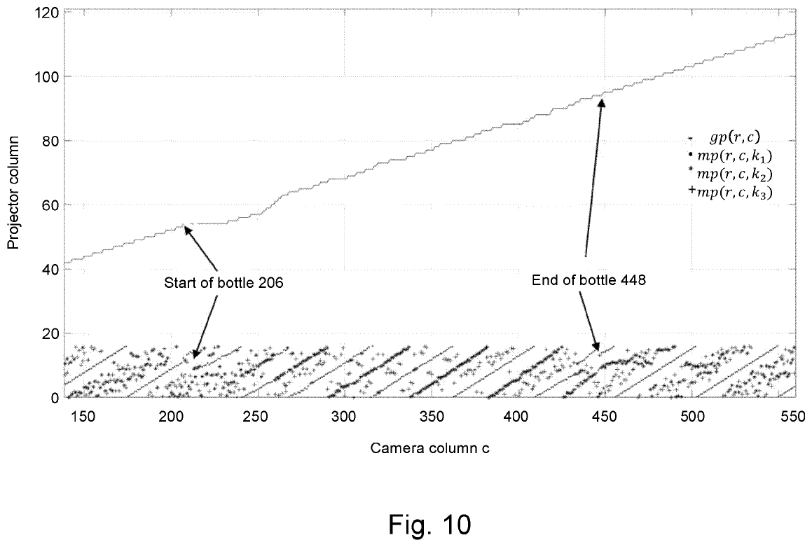

FIG. 10 shows a plot of the values gp(r, c) and mp(r, c, kᵢ) as obtained for each camera pixel in Row A of FIG. 5B. As noted above, the data acquired from the line patterns does not permit the overall column number to be determined, but instead can only be used to determine which of the columns 1 to 16 in a particular set of columns was active at the time in question. For this reason, the values mp(r, c, kᵢ) shown for each camera pixel in FIG. 10 all lie between 1 and 16.

The data signals from the line patterns and the gray code patterns can be combined to obtain the final projector column value fp(r, c, kᵢ) for each peak kᵢ seen at a particular camera pixel by calculating:

$$fp ( r , c , {k}_{i} ) = mod ( mp ( r , c , {k}_{\dot{t}} ) - gp ( r , c ) + o , K ) + gp ( r , c ) \qquad ( Equation 3 )$$

Here, o is an offset used to ensure the alignment of the data from the line patterns and the gray code patterns and mod is the modulo function.

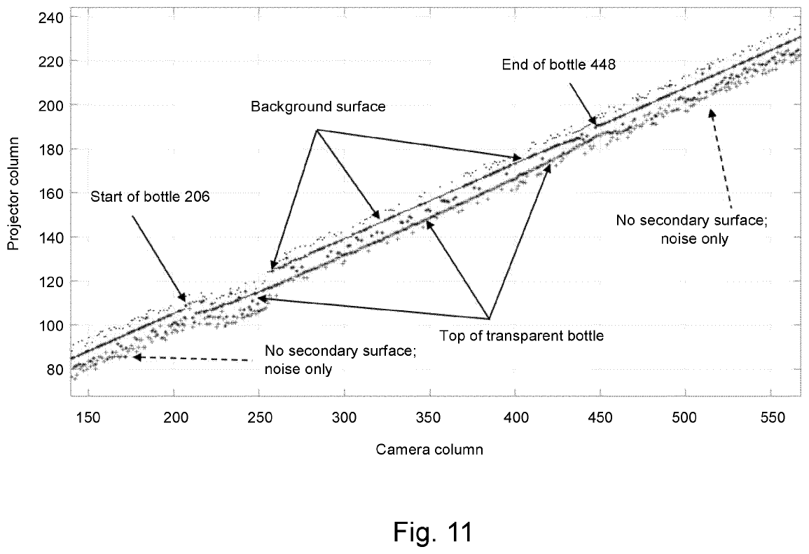

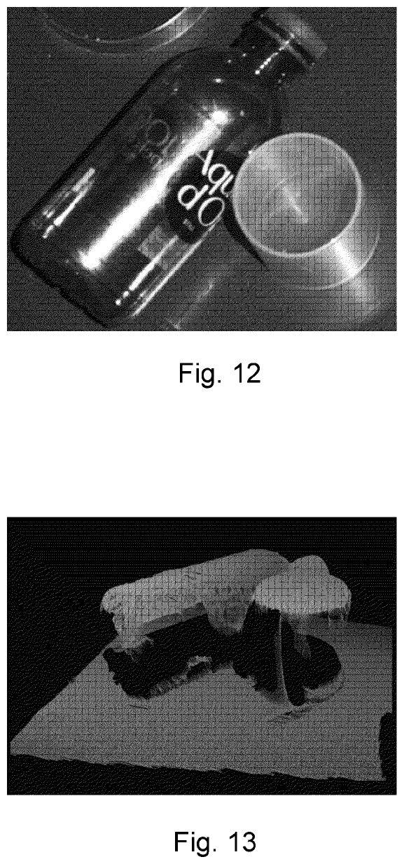

FIG. 11 shows the results of combining the data from the line patterns and the gray code patterns. By analyzing the distribution of points in the graph, it is possible to identify the presence of two surfaces corresponding to the top (transparent) surface of the bottle, and the (background) surface on which the bottle is placed. By extending this analysis to each row of camera pixels, it is possible to construct a point cloud representing the 3 dimensional shape of the objects, including the surface profile of the (upper) transparent surfaces of those objects. (As discussed above, having determined for a given camera pixel that the pixel receiving light from a certain point in the projector array, the coordinates {x, y, z} of a point on the object from which light is being reflected can be determined using known triangulation techniques; in the present case, having determined which column(s) in the projector array the camera pixel is receiving light from, the actual point in the projector array from which that light is emanating can be straightforwardly deduced, since the row number will be known from the geometry of the system). FIG. 13 shows an example 3D reconstruction of the bottle and lid as obtained using this methodology. For ease of comparison, the 3D reconstruction is shown alongside FIG. 12, which reproduces the scene shown in FIG. 5B).

The embodiment described above utilizes a combination of line patterns and gray code patterns to recognize and reconstruct the (upper) transparent surface of the objects in the scene. It will be recognized that the use of gray codes here is optional, and stems from the decision to use multiple illumination lines in each one of the line patterns. In some embodiments, a single column of the projector may be illuminated at each time step in the sequence of line patterns, thereby allowing the absolute column number to be retrieved immediately without the need to also illuminate the scene with the gray code patterns. Limiting the number of illumination lines to a single line in each pattern does, however, carry the cost of a much higher acquisition time. In many applications, therefore, it will be preferable to proceed with a combined multi-line and gray code approach.

Although in the embodiment described above, the illumination patterns are defined by columns in the array of illumination points, this is way by way of example only. In other embodiments, the patterns may be defined using rows in the array of illumination points, or diagonal lines in that array of points. Moreover, the lines need not necessarily be straight, but may be curved.

It will further be appreciated that the line patterns and gray codes described above are one example of a group of illumination patterns that may be used to identify and model transparent surfaces of objects in the scene. A further set of embodiments will now be described in which the problem of identifying the points in the array of illumination points from which a particular camera pixel detects light can be considered as a compressive sensing problem. In this embodiment, the scene is again illuminated with a temporal sequence of illumination patterns, with each pattern being different from the others. Here, the illumination patterns are generated by defining respective illumination sequences for different regions in the array of illumination points. For each region, the illumination sequence defines how the amplitude of light projected from the respective region towards the scene varies at each time step.

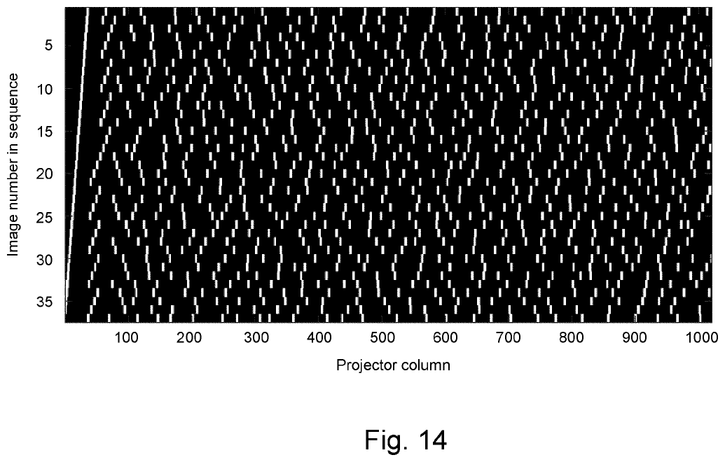

FIG. 14 shows an example of how the illumination sequences may be defined by using a code matrix M. In this example, each region of points in the array of illumination points is taken to be a column in that array; as discussed above, however, this is by no means essential and in other embodiments, the regions may be formed as rows in the array of illumination points, or indeed any one of a number of different shapes formed from points in that array.

Each region (column) is assigned a binary code, which in FIG. 14 can be seen to extend in the vertical direction of the code matrix. In the present embodiment, the code comprises a sequence of bits that define, for each time step, whether or not that particular projector column is to be illuminated. For each column of the matrix, the white elements indicate time steps in the sequence for which the respective projector column should be switched on, whilst the black element indicate time steps in the sequence for which the respective column will be switched off. Thus, each column of the projector may be illuminated more than once throughout the sequence of time steps.

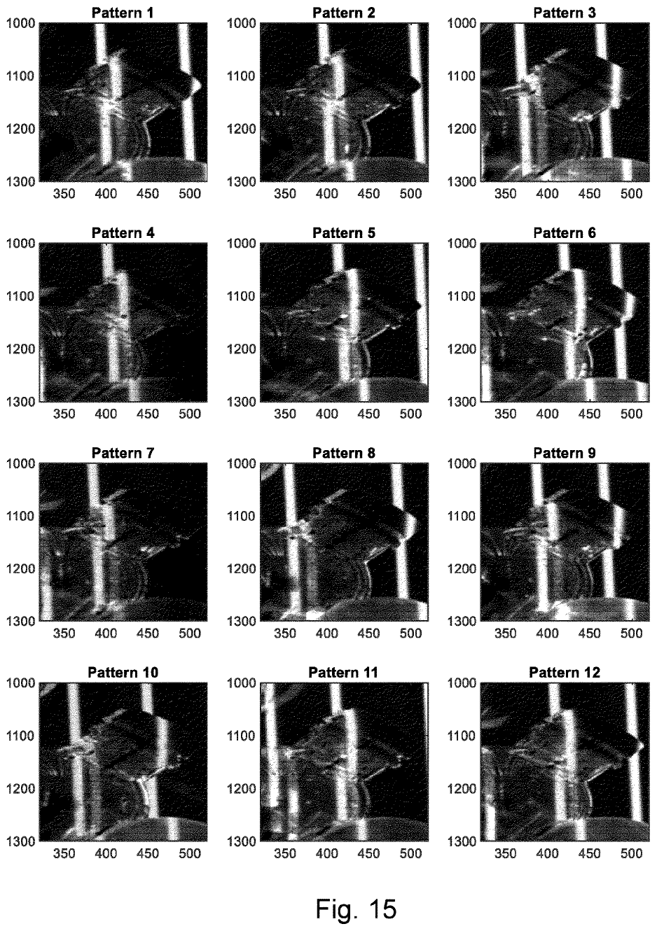

FIG. 15 shows example images captured on the camera when using these different illumination patterns to illuminate the same field of view as shown in FIGS. 6 and 9. Although there will be 37 patterns in total, for conciseness, only 12 are shown in FIG. 15. The images have been normalized per pixel according to the maximum value for that particular pixel across all the images.

As before, each single camera pixel will receive one measurement of intensity sᵢ per time step. These measurements can be combined into a signal vector S={s₁, s₂, . . . , s_{I}} where I is the total number of images captured, equal to the number of time steps in the sequence. The signal vector S will be a linear mixture of the mixture of the codes projected, plus any ambient light A, which can be assumed to be constant during exposure. We can let the linear mixture be represented by a vector R={r₁, r₂, . . . , rₚ}, containing the relative response of each individual code projected.

Subtracting the response from ambient light, the vector R will be very sparse, meaning that most elements will be zero. A reasonable estimate for ambient light can easily be achieved by

$${A}^{′} = {min}_{i} {S}_{i} .$$

This means that the signal vector received by the camera pixel can be modelled as:

$$S = M \times R + A \qquad ( Equation 4 )$$

After subtracting the estimated ambient light S′=S−A′ the observation model can be formed as:

$${S}^{′} = M \times R \qquad ( Equation 5 )$$

(Here, each non-zero element of R will be positive, since it is not possible to “subtract” light from a scene).

The number of non-zero elements in R will depend on the surface being imaged. If the object is not transparent, there will only be a single return signal from the (opaque) surface of the object. This means that R will contain only zero elements, except for one non-zero element representing the return signal from the projector code being returned from the surface. If the object is transparent, there will be a return signal for two of the codes being projected. This means that R will contain only zero elements, except for two non-zero elements, one from the upper (transparent) surface of the object, and one from a second surface located beneath that transparent surface (the same will also be the case if there is a reflection from another object in the scene on top of a non-transparent surface). If we observe a transparent object and a reflection at the same time, three of the elements in R will be non-zero.

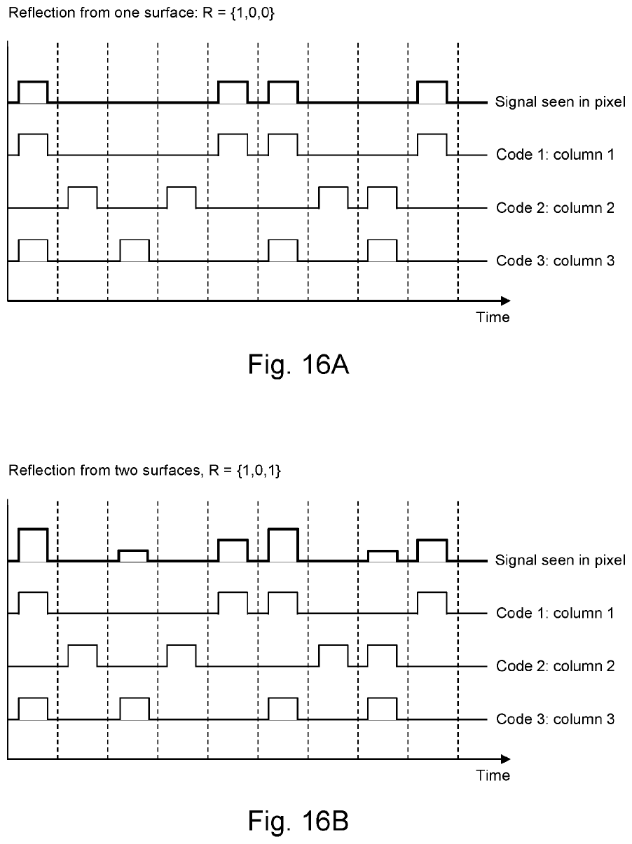

The above principle can be further understood with reference to FIGS. 16A and 16B. FIG. 16A shows an example in which the scene is illuminated with light from three columns on the projector. Each projector column has an illumination sequence encoded as series of bits, which define the time steps at which the projector column is on. In the case of column 1, the illumination sequence may be written as 100011001, indicating that column 1 is to be switched on at time steps 1, 5, 6 and 9. The projector column 2 has the illumination sequence 010100110, meaning it is switched on at time steps 2, 4, 7 and 8. Projector column 3 has the illumination sequence 10100101, meaning it is switched on at time steps 1, 3, 6 and 8. It can be seen from this that each column is switched on a total of four times during the course of the acquisition.

The upper line in FIG. 16A shows the signal detected at a camera pixel over the course of the time sequence. Here, the signal detected at the camera maps directly on to the illumination sequence of projector column 1, with no contribution from projector columns 2 or 3. Following this, the vector R can be determined as R={1, 0, 0}. Since there is only one non-zero element in R, it can be inferred that the object being imaged is opaque, since the light being detected at the camera pixel is only coming from a single one of the columns in the projector array.

Turning to FIG. 16B, the codes for each one of the projector columns 1, 2 and 3 are the same as in FIG. 16A. Here, however, the signal detected at the camera pixel is a linear combination of the codes from columns 1 and 3, thus R={1, 0, 1}. Since the camera pixel is receiving light projected from two separate columns of the projector, it can be inferred that the light from one of those projector columns is being reflected off a first surface in the object that is at least partially transparent, whilst light from the other one of the projector columns is being reflected from a second surface located beneath that transparent surface.

In order to recover the depth of the surface(s), it is necessary, therefore, to solve for R in Equation 5 above.

As I<<P, the linear system is grossly underdetermined, but since R is sparse, it is possible to use a non-negative least squares method to solve the problem and obtain an estimate of R (this estimate being denoted R′ in what follows). More precisely, it is possible to solve:

$${min}_{R ∈ {ℜ}^{n}} {\vert \vert M \times {R}^{′} - {S}^{′} \vert \vert}_{2} , subject to S > 0 \qquad ( Equation 6 )$$

In practice, owing to noise and signal blurring, R will not be fully sparse, but it is still sufficient to obtain an estimate R′ where any very small rᵢ are considered to be zero.

One could envision other optimization targets to achieve the same sparsity, for example:

$${min}_{{R}^{′} ∈ {ℜ}^{n}} ( {\vert \vert M \times {R}^{′} - {S}^{′} \vert \vert}_{2} + λ {‖ {R}^{′} ‖}_{2} ) \qquad ( Equation 7 )$$

where λ is a suitable parameter balancing fit and sparsity. In practice, however, the method set out in Equation 6 above will work well with appropriate algorithms. There are a number of suitable such algorithms known in the art. One example is the Lawson-Hanson algorithm, which performs an iterative optimization of the function, as described in “Solving Least-Squares Problems”, (Lawson, C. L. and R. J. Hanson., Upper Saddle River, NJ: Prentice Hall. 1974. Chapter 23, p. 161). Another method is Orthogonal Matching Pursuit, which performs the same process (see “Matching pursuits with time-frequency dictionaries”, (Mallat S. G., and Zhang, Z., IEEE Transactions on Signal Processing, Vol. 41(12), 1993, p 3397-3415). In summary, these algorithms work by first finding the code r; that matches the received signal S best, and determining which subsequent code can be used to explain the residual D. The process is repeated by adding additional codes through continued iterations until the residual is sufficiently small. It is of course possible to optimize the probing of rt by e.g. using the indices of the maximas of Sᵢ to speed up the process.

After the optimization loop has converged (e.g. the residual D is sufficiently small), one can further remove noise by disregarding elements rᵢ in R′ which are below a chosen threshold. The threshold can be either set absolute or relative to the maximal element of R′, where a relative threshold is the preferred option. Furthermore, in the case of camera pixels having a single return signal, the neighbouring codes are easily included as the secondary candidates. These can be filtered out by post-filtering R′ to remove subsequent non-zero indices, preserving only the maximal rᵢ of the subsequent codes.

By itself, the Lawson-Hanson method (and similar methods) will only determine the closest integer code indices that can explain the signal S′. For enhanced 3D precision, it is necessary to recover the code index with sub-integer precision. In practice, this means refining a detected integer code index rᵢ (and thus projector column) into a projector column/code index

$${r}_{i}^{′}$$

This can be performed by calculation the correlation score

$$CS ( j ) = {\sum }_{i = 1}^{I} M ( i , {r}_{i} + j ) \cdot {S}^{′} ( i ) , - J < j < J$$

with the J neighbouring codes (typically 1-2), fitting a parabola to CS(j) and using the maxima point of the fitted parabola as the sub-integer code index.

The optimization problem can be further constrained by considering the relative disparity window between the camera and the projector. The disparity window defines the number of consecutive columns in the projector array whose light is capable of being detected on the same camera pixel. Owing to the geometry of the light source and the detector, a limit will be placed on that number. Accordingly, codes that are allocated to projector columns that lie outside of that disparity window (i.e. are located more than a certain number of columns away from the column in question) can be excluded from consideration. In most relevant setups, this may exclude up to 90% of the codes, with the contribution from those codes being set to zero for the camera pixel.

There are also possibilities to employ methods based on deep learning to determine the contribution of each code to the signal detected at the camera pixel. An overview of applicable methods is provided in the journal publication “Deep learning for compressive sensing: a ubiquitous systems perspective,” (Machidon, A. L. and Pejović, V., Artificial Intelligence Review, vol. 56, no. 4, pp. 3619-3658 April 2023). These methods can be trained on a dataset generated by performing linear combinations of the codes of M, where a limited number of codes (2-4 typically) are mixed together with different amplitudes and used as input, and with their corresponding code indices used as groundtruth for training the network.

The camera/projector system will blur out the projected codes. This can be compensated by pre-blurring the matrix M with the expected point spread function prior to R′ estimation, and/or performing a local search for neighbouring codes once a primary code is identified in the iterative optimization loop.

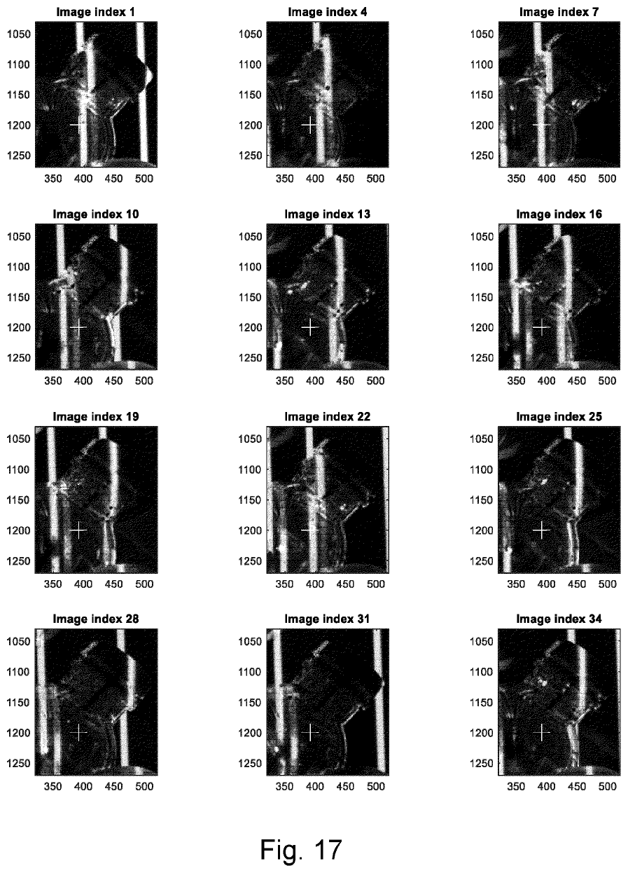

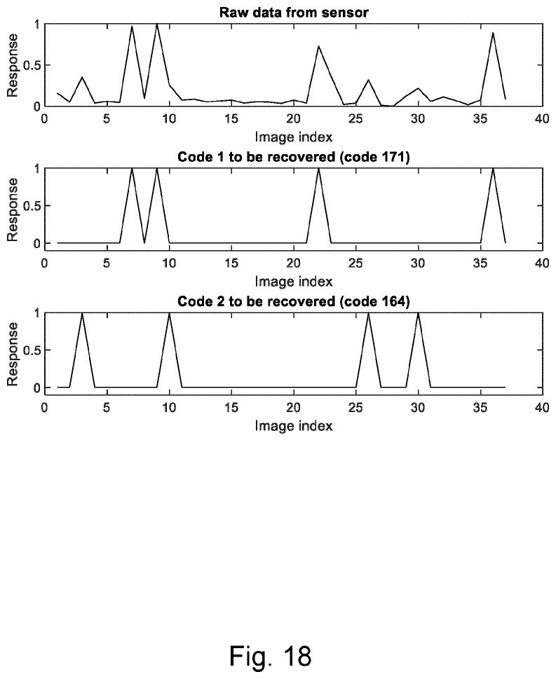

FIGS. 17 and 18 show example image data that further supports the methodology discussed above in reference to FIGS. 14 to 16. FIG. 17 shows example images captured on the camera when using different illumination patterns to illuminate the same field of view. FIG. 18 shows (top line) the intensity values for a single pixel in the image sequence, whilst the two subsequent rows show the codes recovered by un-mixing that system, in this case codes corresponding to columns 171 and 164 on the projector.

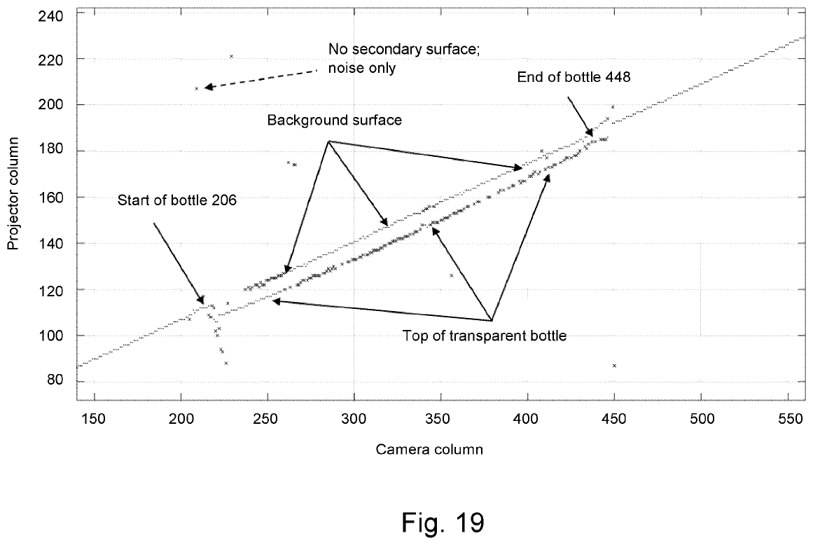

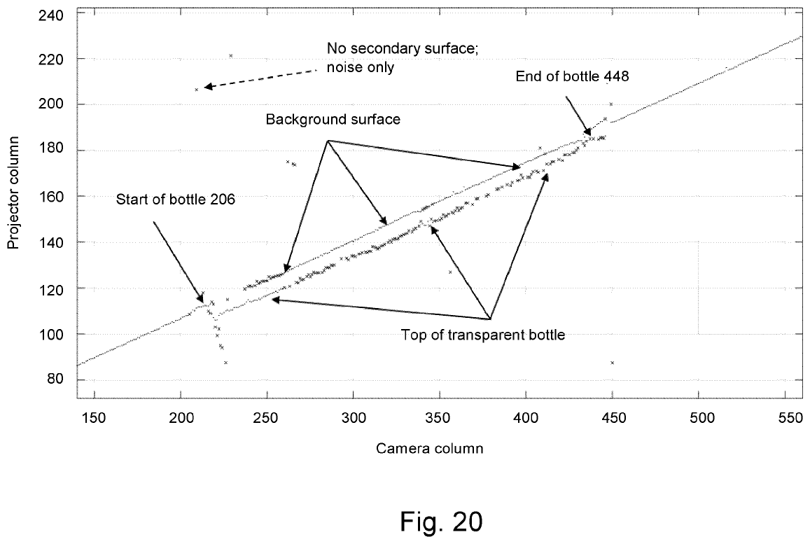

Having determined the codes that contribute to the detected signal, and the corresponding regions (columns) in the array of illumination points, it is possible to generate a plot similar to that shown in FIG. 11. An example is provided in FIG. 19, which shows the top two code indices found per camera pixel for the same image row as displayed in FIG. 11 using the Lawson-Hanson algorithm. It can be seen that the results of the two approaches are comparable, with FIG. 11 including more data points, as well as a greater amount of noise, whilst FIG. 19 includes fewer data points, and much less noise. Since the method can only recover integer indices, the result shown in FIG. 19 has the appearance of a staircase. By using a subcode detection approach based on correlation and parabola fitting, it is possible to achieve a more continuous and smoother line, as shown in FIG. 20.

In general, the methods that provide the results shown in FIGS. 11 and 19 both share a common goal of providing multiple projector indices per camera pixel due to multiple, mixed return signals from the scene, in turn enabling the reconstruction of transparent objects. The method shown in FIG. 11 provides more data points and is very computationally efficient. At the same time, it requires the maximum object thickness to be predefined (to determine the pitch K), and is somewhat more prone to noise close to the true signals. The second, code-based approach described with reference to FIGS. 14 to 20, by contrast, does not require any previous definition of maximum object thickness, making it more applicable in less controlled scenarios. The noise points also tend to be positioned further away from the true signals, making them easier to filter out. The code-based approach can, however, be more computationally expensive, and produce fewer data points.

It will be appreciated that the results obtained using the code-based approach shown in FIGS. 14 to 20 can be enhanced by control of certain parameters. In the embodiment shown here, each code has a constant amplitude (i.e. the number of “on” bits is the same for all codes, meaning that each column of the projector will be illuminated for the same overall amount of time over the course of the acquisition). The number of bit changes in codes for adjacent columns may also be kept constant, somewhat akin to a gray code. These constraints are by no means essential, but can improve the convergence speed of the algorithm.

Moreover, the performance may be improved by reducing the correlation of codes allocated to columns within the disparity window of the system. As is well-known in the art, the disparity window references the code range that can be observed by a single camera pixel due to the geometry of the imaging setup. For one particular camera pixel, an object at zero distance from the camera will observe code index c₀, whilst an object at infinite distance will observe code index c_{∞}. c₀ and c_{∞} will vary with whichever pixel is selected. If prior knowledge on e.g. working range is available (e.g. that all objects will be within a distance d1 and d2, the minimum and maximum code indices per camera pixel can be further reduced, thus limiting the effective disparity window W further.

If W is the disparity window for a projector column p′, then it is desirable for the correlation

$$X ( {p}^{″} ) = {\sum }_{i = 1}^{I} M ( i , {p}^{′} ) \cdot M ( i , {p}^{″} ) , \vert {p}^{″} - {p}^{′} \vert < W ∧ \vert {p}^{″} - {p}^{′} \vert > C ) \}$$

to be as low as possible for all p″, with the exception of the codes that are less than C code indices away from p′, where C is the width of the main lobe of the cross-correlation matrix. The precise value of C will vary according to the code design strategy but for a code design similar to the one exemplified in FIG. 14, where one has four bits switched on per code, and one bit is switched on and one off per transition, the main lobe has a width of C=3. This effective disparity window can also be used during runtime to optimize the performance of the decoding algorithm, as mentioned earlier.

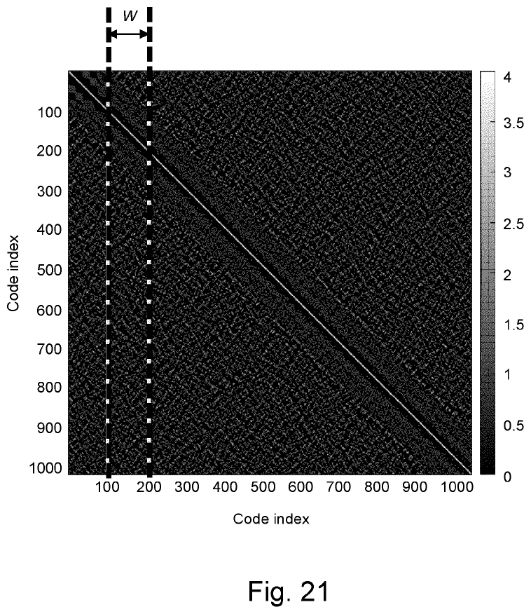

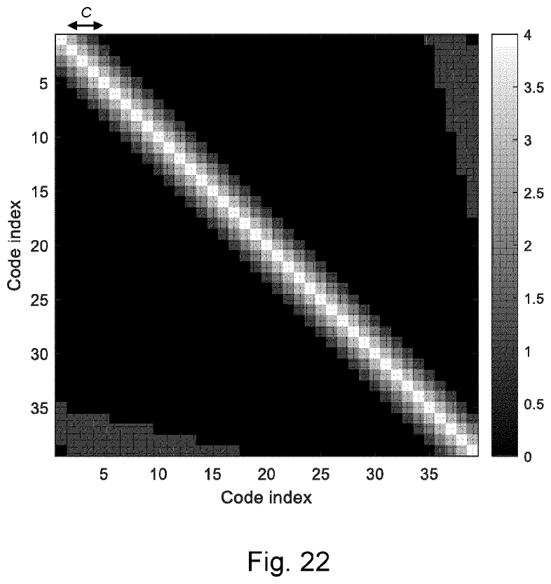

The improvement afforded by controlling the above parameters can be understood with reference to FIGS. 21 to 25. In more detail, FIG. 21 shows the cross-correlation matrix for the codes shown in FIG. 14 (and using which the results shown in FIG. 19 were obtained). It can be seen here that the intensity along the diagonal is constant, this being a result of the fact that each code has the same number of “on” bits. It can also be seen in FIG. 14 that the correlation between codes is particularly reduced for columns that are located close to the column in question and which lie within the disparity window; by reducing this correlation, it is possible to minimize interference between those columns whose light is capable of being detected in the same camera pixel. FIG. 22 shows a magnified section of the matrix of FIG. 21, in which the width C of the main lobe can be seen to equal that of three columns. C should preferably also be kept as low as possible, but in practice a trade-off between W, C, I and X must be found to strike a balance between performance and time. In the exemplified case, W=100, C=3, I=37, X≤1.0 where I is the number of images in the sequence.

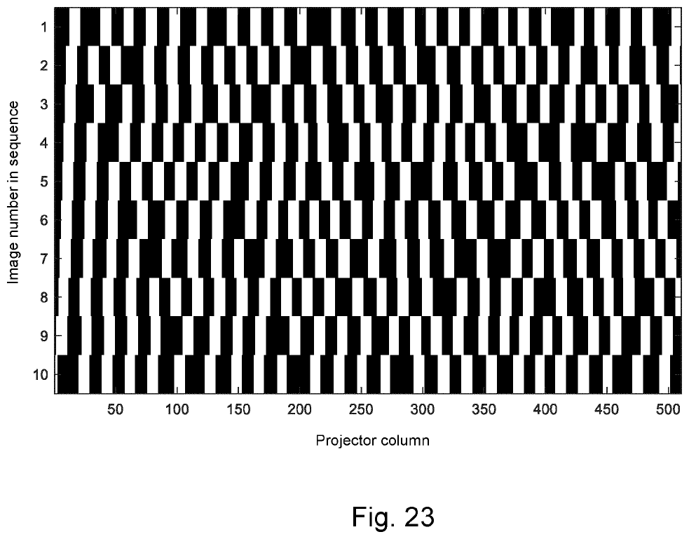

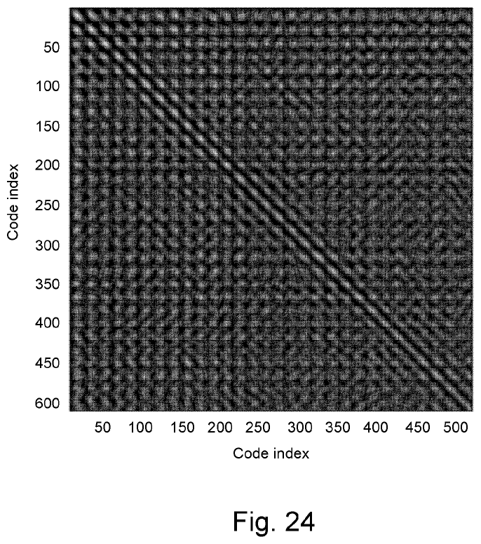

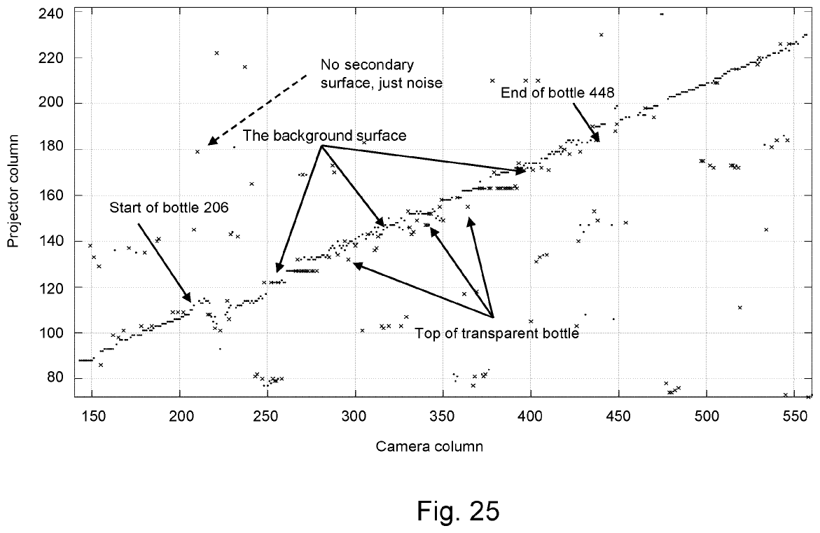

As a comparative example, FIG. 23 shows an alternative code matrix in which the only constraint that is applied is that a single bit changes between consecutive codes (note that although the codes for pairs of consecutive columns are the same in this example, this does not affect the results). FIG. 24 shows the cross-correlation matrix for the code matrix shown in FIG. 23. In contrast to the cross-correlation matrix shown in FIG. 21, the intensity along the diagonal varies quite strongly; this is due to the fact that the number of “on” bits per code varies, meaning that signal normalization is required. There is also no clear band around the main diagonal where interference is minimized; this is due to that no effort has been made to design the code such that the correlation between codes within the disparity window is minimized. FIG. 25 shows the results obtained when using the code matrix to identify the column(s) whose light is incident on each camera pixel. Here, the presence of the secondary surface can still be resolved, but the reconstruction is not as successful as in FIG. 19.

It will be appreciated that whilst the embodiments described above with reference to FIGS. 14 to 25 rely on the regions (columns) being switched “on” and “off” at different time steps, in practice, the intensity of the light source may still have a finite amplitude at each time step; that is, the system may be configured such that for time steps in the sequence where the column is “off”, light will still emanate from that region of the array of illumination points, but with a reduced amplitude compared to time steps where the column is “on”. In the extreme case, this reduced amplitude may be zero, but in general “off” need not signify the absence of signal altogether.

Moreover, in some embodiments, the illumination sequence for each region (e.g. column) may be defined by applying a particular frequency modulation to the amplitude of light emanating from that region. That is, rather than each region having a binary sequence of “on” and “off” periods throughout the course of the acquisition, the amplitude of the intensity may be made to vary more continuously over the course of the acquisition. For example, the intensity of light emanating from each region may vary sinusoidally over the course of the image frames, with the frequency of that modulation being different for each region. In this case, each illumination sequence may still be encoded using one or more bits, but here the bits will encode the frequency modulation to be applied for that region. The signal then detected at each camera pixel over the course of the image acquisition will be a sum of the frequencies associated with regions in the array of illumination points from which light incident on the camera pixel is emanating. In a similar way to that described above, the signal detected on the camera can be unmixed to recover the contributing frequencies, and in turn the regions (columns) from which light detecting in that pixel is emanating.

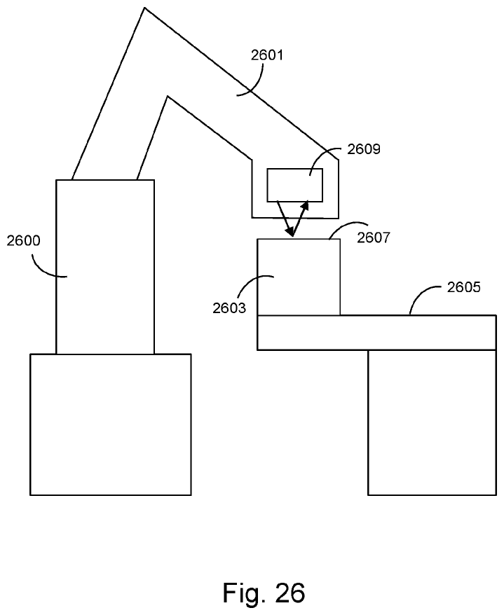

FIG. 26 shows an example in which an imaging system according to an embodiment is employed by a robotic device in a factory or warehouse. The robotic device 2600 may be one of a number of such devices operating in the factory or warehouse.

The robotic device 2600 includes one or more arms 2601 configured to manipulate an object 2603. The robotic arm 2601 may be used to lift the object 2603 off a shelf 2605 on which the object is placed, for example. In order to do so, the robotic device will need to determine the object's position in space in order to properly engage with the object. The robotic device's ability to do so may be compromised, however, if the object 2603 has a transparent surface 2607, as this may be difficult for the robotic device to properly detect; this might be the case, for example, if the object is made of plastic or has a transparent packaging. In the event the robotic device fails to detect the transparent surface, the robotic arm may be brought down too far, penetrating the transparent surface 2607 and damaging the object 2603. To allow the robotic device to successfully map the object's position in space, the robotic device may utilize an imaging system as described herein to detect whether or not the object has one or more transparent surfaces, and to adjust its position accordingly. In the example shown in FIG. 26, the robotic device itself includes an imaging system 2609 according to the embodiments described herein, which it uses to map the surface(s) of the object prior to engaging with it. It will be appreciated, however, that the imaging system need not be part of the robotic device itself, but could be housed separately from the robotic device, and used to feed information about the object to the robotic device prior to its engaging with the object 2003.

The imaging system may also be used for inspecting the surface of transparent objects. In this case, the 3D data captured of the transparent surfaces would be compared with e.g. CAD models to look for defects, or one could use local surface characterization methods (e.g. edge detection filters) to detect surface imperfections. In the case of a defect is detected, either a robotic device similar to FIG. 26 may be used to remove the object, or one may log the error in a suitable database for later processing and handling of the part.

It will be appreciated that implementations of the subject matter and the operations described in this specification can be realized in digital electronic circuitry, or in computer software, firmware, or hardware, including the structures disclosed in this specification and their structural equivalents, or in combinations of one or more of them. Implementations of the subject matter described in this specification can be realized using one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

While certain embodiments have been described, these embodiments have been presented by way of example only and are not intended to limit the scope of the invention. Indeed, the novel methods, devices and systems described herein may be embodied in a variety of forms; furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

1. An imaging system for imaging a scene comprising one or more objects, the system comprising:
a light source arranged to illuminate the scene by projecting light rays through an array of points in space, wherein for each one of a sequence of time steps, the light source is configured to illuminate the scene with a different illumination pattern by projecting light rays through a different group of points in the array;
a detector comprising an array of pixel elements, the detector being arranged to capture an image at each time step by detecting, on the array of pixel elements, light projected towards the scene and reflected from one or more surfaces of the object towards the detector; and
an image processor configured to:
process the captured images to determine, for each pixel element, a light signal incident on the pixel element during the course of the sequence of time steps; and
determine, based on the light signal incident on the pixel element at each time step and knowledge of the illumination pattern projected at each time step, that the object includes a first surface that is at least partially transparent, at least a portion of the light incident on the first surface being reflected towards the detector, and another portion being reflected from a second surface located at a greater depth in the scene.

2. The system according to claim 1, wherein the image processor is configured to determine, based on the light signal incident on the pixel element at each time step and the illumination pattern at each time step, that the light signal includes a first portion of light reflected from the first surface, and a second portion of light reflected from the second surface.

3. The system according to claim 2, wherein the first portion of light and the second portion of light travel along the same path between the object and the detector.

4. The system according to claim 1, wherein the image processor is further configured to determine, based on the light signal incident on the pixel element at each time step and the illumination pattern at each time step:
a first location in the array of illumination points through which the light reflected by the first surface and incident on the pixel element was projected; and
wherein the in processor is further configured to determine, based on the light signal incident on the pixel element at each time step and the illumination pattern projected at each time step;
a second location in the array of illumination points through which the that passed through the first surface and was reflected from the second surface towards the pixel element was projected.

5. (canceled)

6. (canceled)

7. The system according to claim 1, wherein the illumination patterns comprise a series of line patterns in which one or more lines are projected onto the scene.

8. The system according to claim 7, wherein each line pattern comprises a plurality of parallel lines.

9. (canceled)

10. The system according to claim 7, wherein the line patterns are chosen such that each line is projected onto the scene once over the sequence of time steps.

11. The system according to claim 7, wherein the image processor is configured to determine that the object includes a first surface that is at least partially transparent by identifying the presence of two or more peaks in the light signal incident on the pixel element over the course of projecting the lines patterns onto the scene, and
wherein the image processor is configured to identify a region of the array of illumination points through which light reflected by the first surface and incident on the pixel element passed based on the peaks in the light signal incident on the pixel element during the course of illuminating the scene with the plurality of line patterns.

12. (canceled)

13. The system according to claim 10, wherein the illumination patterns further comprise a series of coded patterns from which can be determined a global location in the array of illumination points through which light rays incident on each pixel of the detector pass.

14. (canceled)

15. The system according to claim 13, wherein the image processor is configured to identify a region of the array of illumination points through which light reflected by the first surface and incident on the pixel element passed based on (i) the peaks in the light signal incident on the pixel element during the course of illuminating the scene with the plurality of lines patterns and (ii) the signal seen in the detector pixel over the course of illuminating the scene with the coded patterns.

16. The system according to claim 1, wherein the light source is configured to generate the illumination patterns by defining an illumination sequence for respective regions of points in the array of illumination points, the illumination sequence specifying a variation in the amplitude of light projected through the respective region over the course of the sequence of time steps, the illumination sequence being different for each region.

17. (canceled)

18. The system according to claim 16, wherein for each pixel element, the image processor is configured to model the light signal incident on the pixel element over the sequence of time steps as a function of contributions from the regions in the array of illumination points;
the image processor being configured to determine a number of regions N whose illumination sequences, when combined, result in the light signal seen on the detector;
wherein the image processor is configured to determine that the object includes a first surface that is at least part ent and a second surface in the event that N≥2.

19. (canceled)

20. The system according to claim 16, wherein each illumination sequence is encoded using one or more bits, the one or more bits defining a relative amplitude of light to be projected through the region of points towards the scene in each time step.

21. The system according to claim 20, wherein the one or more bits specify a frequency modulation to be applied to the light projected through the region of points over the course of the sequence of time steps.

22. The system according to claim 20, wherein each illumination sequence is encoded as a sequence of bits, wherein each bit is associated with a respective time step, the value of each bit defining a relative amplitude of light to be projected through the region of points towards the scene in the respective time step.

23. The system according to claim 22, wherein for each region, the illumination sequence defines one or more time steps at which light is to be projected from the region with a first amplitude, and one or more time steps at which the amplitude of light projected from the region is either reduced compared to the first amplitude or is zero.

24. The system according to claim 23, wherein the illumination sequences are defined such that for each one of the region of points, the number of time steps in the sequence for which light will be projected with the first amplitude is the same; or
wherein each region of points comprises a respective line of points in the array of illumination points and wherein the number of bit changes between the illumination sequences for each consecutive pair of lines is the same.

25. (canceled)

26. The system according to claim 22, wherein the regions comprise columns or rows of points in the array of illumination points and the sequence of bits for each region is defined such that for any one region, a correlation between the sequence of bits for that region and the sequence of bit for other regions within a disparity window of that region is reduced compared to the correlation between the sequence of bits for that region and the sequence of bits for other regions outside of the disparity window, the disparity window defining the maximum number of consecutive regions in the array of illumination points, the light from which is capable of being detected on a single pixel of the detector according to the geometry of the system.

27. The system according to claim 1, wherein the light source comprises a projector having an array of projector elements, each illumination pattern being generated by activating one or more of the projector elements.

28. A robotic device configured to manipulate a physical object, wherein the robotic device is configured to identify the object as having a transparent surface by using a system according to claim 1.

29. A warehouse comprising one or robotic devices according to claim 28.

30. A non-transitory computer-readable medium comprising computer executable instructions that when executed by a computer will cause the computer to operate a system according to claim 1 or to operate a robotic device configured to manipulate a physical object, wherein the robotic device is configured to identify the object as having a transparent surface by using an imaging system for imaging a scene comprising one or more objects, the system comprising:
a light source arranged to illuminate the scene by projecting light rays through an array of points in space, wherein for each one of a sequence of time steps, the light source is configured to illuminate the scene with a different illumination pattern by projecting light rays through a different group of points in the array;
a detector comprising an array of pixel elements, the detector being arranged to capture an image at each time step by detecting, on the array of pixel elements, light projected towards the scene and reflected from one or more surfaces of the object towards the detector; and
an image processor configured to:
process the captured images to determine, for each pixel element, a light signal incident on the pixel element during the course of the sequence of time steps; and
determine, based on the light signal incident on the pixel element at each time step and knowledge of the illumination pattern projected at each time step, that the object includes a first surface that is at least partially transparent, at least a portion of the light incident on the first surface being reflected towards the detector, and another portion being reflected from a second surface located at a greater depth in the scene.
